(19) United States
(12) Patent Application Publication
(10) Pub. No.: US 2019/0390721 A1
(43) Pub. Date: Dec. 26, 2019

(54) MAGNETORHEOLOGICAL FLUID CLUTCH AND OPERATION METHOD THEREOF

(71) Applicant: NATIONAL TSING HUA UNIVERSITY, Hsinchu (TW)

(72) Inventors: Manuel Alejandro Fernandez LOPEZ, Hsinchu (TW); Jen-Yuan Cheng, Baoshan Township (TW)

(21) Appl. No.: 16/228,112

(22) Filed: Dec. 20, 2018

(30) Foreign Application Priority Data
Jun. 21, 2018 (TW) 107121374

(51) Int. Cl. F16D 37/02; B25J 9/14; B25J 9/12

(52) U.S. Cl. CPC F16D 37/02; F16D 2037/005; B25J 9/126; B25J 9/146

(57) ABSTRACT

A magnetorheological fluid clutch and an operation method are provided. The magnetorheological fluid clutch includes an output component, a permanent magnet, an input component, magnetorheological fluid, and a field blocker. The permanent magnet is disposed in an accommodating space of the output component. The input component is set into the output component. The magnetorheological fluid is disposed between the output component and the input component. The state of the magnetorheological fluid is controlled by a magnetic field generated from the permanent magnet. The field blocker is inserted into the space between the permanent magnet and the output component to control the intensity of the magnetic field.

This application claims priority from Taiwan Patent Application No. 107121374, filed on Jun. 21, 2018, in the Taiwan Intellectual Property Office, the content of which is hereby incorporated by reference in its entirety for all purposes.

### BACKGROUND OF THE INVENTION

### 1. Field of the Invention

The present disclosure relates to a magnetorheological fluid clutch and an operation method thereof, especially a state of the magnetorheological fluid is controlled by a magnetic field generated by using a permanent magnet, so as to provide the torque output of the clutch.

### 2. Description of the Related Art

A magnetorheological fluid (MRF) is a special material which carries magnetic particles in a liquid solution. Without a magnetic field in action, the particles in the magnetorheological fluid become randomly distributed so that the magnetorheological fluid remains in a flowing state. However, when being affected by a magnetic field, the particles in the magnetorheological fluid will adapt a regular catenation alignment along with the direction of the magnetic field and will restrict the liquid solution from flowing so that the magnetorheological fluid adapts a semisolid state. After the disappearance of the magnetic field, the magnetorheological fluid will again return to the flowing state immediately. Because of characteristics such as quick switching between the states, the applications in clutches, damping, and braking devices have attracted considerable attention.

In terms of a clutch, a traditional clutch is used to control power transmission between an input end and an output end, such as the motor driving of a car and power transmission between axles. Based on the characteristics of the magnetorheological fluid mentioned above, if the magnetorheological fluid is disposed between the input end and the output end, by applying a magnetic field, the states of the magnetorheological fluid can be changed rapidly and the corresponding shearing force can be generated to quickly control the fixation and the separation between platters. However, the method of applying the magnetic field to the magnetorheological fluid nowadays requires disposing coils to generate the magnetic field, but extra space is needed for coils, circuits with addition of voltage, and signal control systems, as well as the need for heat dissipation. For devices that need microminiaturization, there are limitations which can be found on the design.

Hence, to solve the above-mentioned problems, the present disclosure designs a magnetorheological fluid clutch and an operation method thereof to improve deficiencies in terms of current techniques so as to enhance the implementation and application in industries.

### SUMMARY OF THE INVENTION

In view of the above-mentioned problems, the purpose of the present invention is to provide a magnetorheological fluid clutch and an operation method thereof to solve the problems that requires disposing coils for a magnetorheological fluid clutch, resulting in devices not being able to be microminiaturized and having the need for heat dissipation mechanism.

A magnetorheological fluid clutch includes an output component, a permanent magnet, an input component, a magnetorheological fluid, and a field blocker, wherein the output component forms an accommodating space by an inner sidewall. The permanent magnet is disposed in the accommodating space, and a first interval is provided between the permanent magnet and the inner sidewall. The input component is set into the inner sidewall of the output component, and a second interval is provided between the input component and the inner sidewall. The magnetorheological fluid is disposed in the second interval, and a viscosity of magnetorheological fluid is controlled by a magnetic field generated by the permanent magnet. The field blocker is inserted into the first interval, and controls the intensity of the magnetic field.

Preferably, the field blocker is connected to a guiding rod to adjust the insertion depth of the field blocker and control the intensity of the magnetic field by the guiding rod.

Preferably, the field blocker includes a plurality of cylinders, the plurality of cylinders has different inner diameters, and the intensity of the magnetic field is controlled by folding the plurality of cylinders.

Preferably, the field blocker includes a plurality of blocking pieces, and a proportion covering permanent magnet is adjusted to control the intensity of the magnetic field by rotating the plurality of blocking pieces.

Preferably, the inner sidewall includes a concave slot, and the input component is inserted into the concave slot to be set into the output component.

Preferably, the input component includes a bearing attaching to the inner sidewall.

Preferably, the output component is connected to a driving device of a robotic arm.

Preferably, the input component is connected to a driving motor.

An operation method of a magnetorheological fluid clutch is disclosed. The operation method includes the following steps: disposing the magnetorheological fluid clutch which includes an output component, an input component, and a permanent magnet, and a magnetorheological fluid is provided between the output component and the input component; inserting a field blocker into a first interval between the output component and the permanent magnet, blocking the magnetic field of the permanent magnet; and adjusting the field blocker to control the intensity of magnetic field while changing the viscosity of the magnetorheological fluid to control a torque output of the output component.

Preferably, the step of adjusting the field blocker includes adjusting an insertion depth of the field blocker by using a guiding rod.

Preferably, the step of adjusting the field blocker includes folding a plurality of cylinders of the field blocker.

Preferably, the step of adjusting the field blocker includes rotating a plurality of blocking pieces of the field blocker to adjust a proportion covering the permanent magnet.

Preferably, the operation method of the magnetorheological fluid clutch further includes driving the input component through a driving motor, and receiving the torque output by a driving device to control a robotic arm.

According to what is mentioned above, the magnetorheological fluid clutch and the operation method thereof have more than one advantages described in the following:

(1) The magnetorheological fluid clutch and the operation method thereof can utilize change of states about the magnetorheological fluid to control the fixation and separation of the input end and output end. In this way, the states of magnetorheological fluid can be switched rapidly, the power transmission becomes faster, and power transfer becomes more efficient.

(2) The magnetorheological fluid clutch and the operation method thereof can utilize the magnetic field generated by the permanent magnet to control the change of states about the magnetorheological fluid. There is no need to set up coils to generate the magnetic field. Installation of heat dissipation devices is also unnecessary. In this way, space for devices can be saved for other uses.

(3) The magnetorheological fluid clutch and the operation method thereof can control magnetic field changes by a field blocker. Through the rotation of mechanism to control the insertion depth and covering proportion, controlling can be easily proceeded. There is no need to set up extra electric control devices, simplifying the design and enhancing the convenience of operation.

### BRIEF DESCRIPTION OF THE DRAWINGS

FIG. 1 is a sectional diagram of pre-assembled components of the magnetorheological fluid clutch of the embodiment of the present disclosure.

FIG. 2 is a sectional diagram of post-assembled components of the magnetorheological fluid clutch of the embodiment of the present disclosure.

FIG. 3 is a diagram of the field blocker of another embodiment of the present disclosure.

FIG. 4 is a diagram of the field blocker of the other embodiment of the present disclosure.

FIG. 5 is a diagram of the application of the magnetorheological fluid clutch on a robotic arm of the embodiment of the present disclosure.

FIG. 6 is a chart of the embodiment of the present disclosure which shows the relation between the field blocker's insertion depth and output torque.

FIG. 7 is a flow chart of the magnetorheological fluid clutch operation method of the embodiment of the present disclosure.

### DESCRIPTION OF THE PREFERRED EMBODIMENTS

To facilitate the review of the technique characteristics, contents, advantages, and achievable effects of the present invention, the embodiments together with the drawings are described in detail as follows. However, the drawings are used only for the purpose of indicating and supporting the specification, which is not necessarily the real proportion and precise configuration after the implementation of the present invention. Therefore, the relations of the proportion and configuration of the attached drawings should not be interpreted to limit the actual scope of implementation of the present invention.

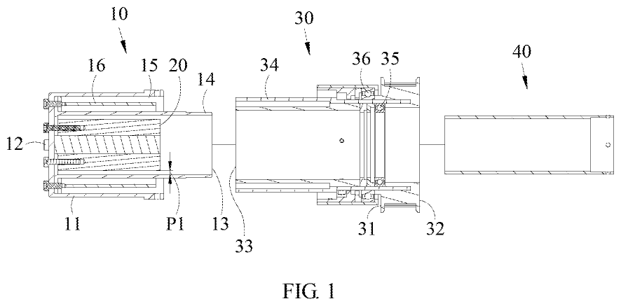

Please refer to FIG. 1, illustrating the sectional diagram of pre-assembled components of the magnetorheological fluid clutch of the embodiment of the present disclosure. As indicated in the drawings, the magnetorheological fluid clutch includes an output component 10, a permanent magnet 20, an input component 30, and a field blocker 40. The output component 10 includes a first casing 11. One end of the first casing 11 is connected to an output axis 12 that outputs power, whereas the other end includes an opening 13. The inside of the first casing 11 is a hollow structure, forming an accommodating space by the inner sidewall 14 and extending to the opening 13. The permanent magnet 20 is disposed in the accommodating space. In this embodiment, the permanent magnet 20 is designed as a cylindrical structure, and fixed at the inner center of the first casing 11 in the accommodating space to create a first interval P1 between the permanent magnet 20 and the inner sidewall 14 of the output component 10.

The input component 30 includes a second casing 31 in the shape of a cylinder. One end of the second casing 31 is connected to the power input end 32, whereas the other end includes an opening 33. The diameter of the second casing 31 of the input component 30 is less than that of the first casing 11 of the output component 10, making the input component 30 able to be set into the output component 10. In this embodiment, the inner sidewall 14 of the output component 10 can form a concave slot 15 so that the second casing 31 of the input component 30 can be inserted and further set into the output component 10. Moreover, the inside of the concave slot 15 can include a protruding component 16. From the second casing 31, the input component 30 then corresponds to a U-shaped component 34 so that the input component 30 can be set into the concave slot 15. In addition, the second casing 31 of the input component 30 can be provided with bearings 35, 36 disposed near the power input end 32 at inner or outer sidewalls. When the input component 30 is set into the output component 10, the inner sidewall 14 of the output component 10 will be contacted and supported. When making contact with the output component 10, the bearings will be considered axis components rotating with each other.

The field blocker 40 reduces the magnetic field by blocking the permanent magnet 20. In this embodiment, the ferromagnetic material can be used to design a hollow cylindrical structure so that it can be inserted in the first interval P1 and cover the permanent magnet 20. By the material of the field blocker 40 having the characteristics of magnetism, the intensity of the magnetic field generated by the permanent magnet 20 can be controlled.

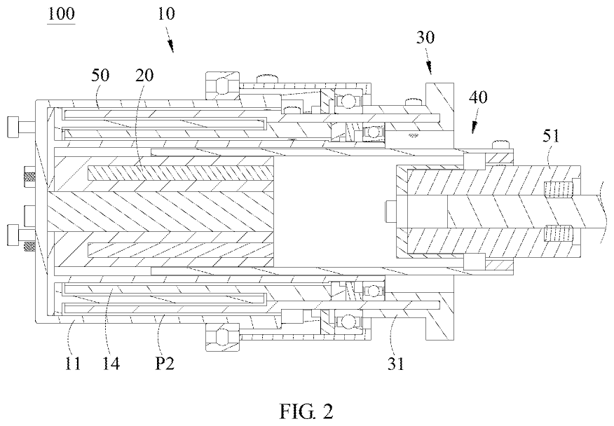

Please refer to FIG. 2, illustrating the sectional diagram of post-assembled components of the magnetorheological fluid clutch of the embodiment of the present disclosure. As indicated in the drawing, the magnetorheological fluid clutch 100 includes an output component 10, a permanent magnet 20, an input component 30, and a field blocker 40. The structure and content is the same as those of the components described above will not be explained again. In this embodiment, the structure of the input component 30 being set into the output component 10 will mainly be presented. After the sidewall of the second casing 31 of the input component 30 is inserted into the concave slot 15, there is a second interval P2 between the inner sidewalls 14 of the first casing 11 of the output component 10. The second interval P2 is filled with the magnetorheological fluid 50. In this embodiment, the space between the output component 10 and the input component 30 is filled with the magnetorheological fluid 50. Without the existence of the magnetic field, the magnetorheological fluid 50 adapts a flowing state, and the output component 10 is separated from the input component 30. When applying a magnetic field, the viscosity of the magnetorheological fluid 50 changes and adapts a semisolid state so that the output component 10 and the input component 30 fix together. With the magnetorheological fluid being able to quickly switch states, the response time of the magnetorheological fluid clutch 100 becomes short, which makes power transmission even faster. In addition, reducing the chances of the output component 10 and the input component 30 directly making contact with each other means reducing the possibility of friction between metals. Not only unnecessary vibration or noise can be avoided, but the life span of the clutch can also be increased.

In this embodiment, the magnetorheological fluid clutch 100 is not provided with coils that generate a magnetic field, nor a circuit transmitting a control signal. Only a permanent magnet 20 is disposed and its generated magnetic field is used to control the states of the magnetorheological fluid 50. Compared to the method of using coils in current techniques, the magnetorheological fluid clutch 100 in this embodiment can effectively reduce the use of spaces for coils and control circuit. For devices or equipment that requires the magnetorheological fluid clutch 100, spaces can be used more effectively or device microminiaturization can be expected. In addition, adding voltage to coils will generate heat energy, which forces designers to take into consideration the problem of heat dissipation. This further increases the complexity of structure and decreases the convenience of operation. The permanent magnet 20 introduced in this embodiment can be used to solve the problems in current techniques mentioned above. However, the magnetic field generated by the permanent magnet 20 does not disappear, which cannot change the states of the magnetorheological fluid 50. The field blocker 40 has to be used to shield the magnetic field, so the variation of the magnetic field will change the states of the magnetorheological fluid 50, thereby controlling the switch of the fixation and separation between the output component 10 and the input component 30.

Please refer to FIG. 1 and FIG. 2 at the same time. The diameter of the field blocker 40 is larger than that of the permanent magnet 20, which enables the field blocker 40 to be inserted into the first interval P1 to cover the permanent magnet 20. By the characteristics of magnetism of the ferromagnetic material of the field blocker 40, the magnitude of the magnetic field originally applied to the magnetorheological fluid 50 can be controlled, further controlling the torque output of the input component 30. In this embodiment, the method of controlling the magnitude of the magnetic field can be realized by means of the insertion depth of the field blocker 40, namely the distance between the tail end of the field blocker 40 and the opening 13 of the output component 10. The deeper the insertion depth is, the larger the area of the field blocker 40 covering the permanent magnet 20 will be. The more the magnetic field is shielded, the smaller the magnetic field applied to the magnetorheological fluid 50, which makes the magnetorheological fluid 50 inclined to be a flowing state. By contrast, shallow insertion depth diminishes the area of the field blocker 40 covering the permanent magnet 20 and increases the magnetic field applied to the magnetorheological fluid 50. The alignment of magnetic particles in the magnetorheological fluid 50 increases the viscosity of the fluid, inclines to a semisolid state, and further fix the output component 10 and the input component 30. The field blocker 40 can adjust the insertion depth by the guiding device 51 to control the intensity of the magnetic field generated by the permanent magnet 20. However, the present disclosure is not limited herein. The field blocker in different structures will be explained by embodiments below.

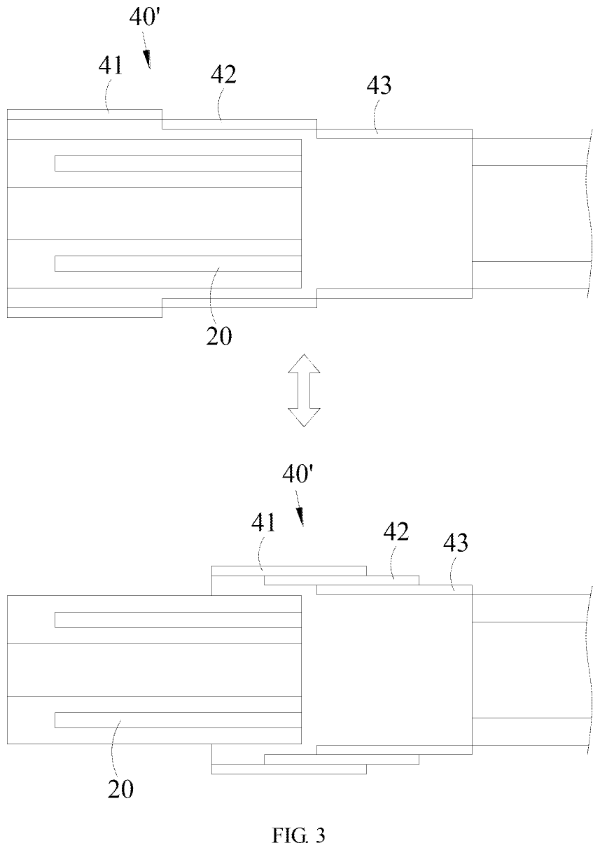

Please refer to FIG. 3, illustrating the diagram of the field blocker of another embodiment of the present disclosure. As indicated in the drawing, the field blocker 40′ includes first cylinder 41, second cylinder 42, and third cylinder 43 and so on in cylindrical structure of different inner diameters. This embodiment is exemplified by three cylinders, but the present disclosure is not limited by the number of cylinders in this embodiment. With different sizes of clutch devices, the inner diameter of the cylinders and the number of cylinders can be adjusted in accordance with requirements. The setup of the field blocker 40′ in this embodiment can cover the permanent magnet 20 so as to block the generated magnetic field. Due to the difference in the inner diameter of each cylinder, the cylinder can be folded to change the length of the field blocker 40′. Please refer to the lower part of FIG. 3. When the first cylinder 41 and the second cylinder 42 are folded, the length of the entire field blocker 40′ is shortened. At the moment, the magnetic field generated by the permanent magnet 20 will not be shielded. By controlling the folding length, the intensity of the magnetic field can be controlled, and the states of the magnetorheological fluid 50 can also be controlled. In this embodiment, the third cylinder 43 can be fixed, and only the first cylinder 41 and the second cylinder 42 can be moved. To the entire clutch device, the length of field blocker 40′ protruding the device can be shortened, and the size of the clutch device can further be diminished.

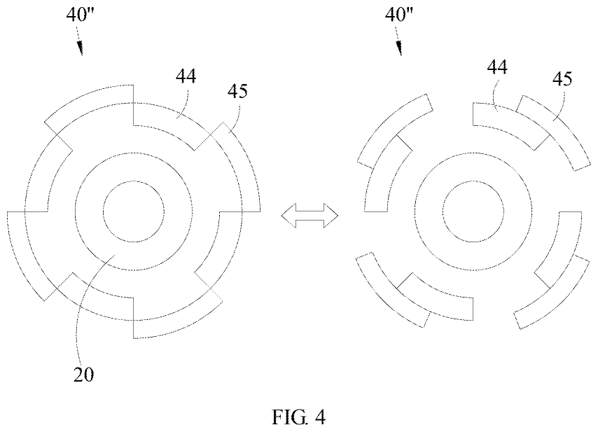

Please refer to FIG. 4, illustrating the diagram of the field blocker of the other embodiment of the present disclosure. As indicated in the drawing, the field blocker 40″ includes a plurality of first blocking pieces 44 and a plurality of second blocking pieces 45. The first blocking pieces 44 are connected to the second blocking pieces 45, but the distance from the first blocking pieces 44 and that from the second blocking pieces 45 to the permanent magnet are different. In addition, by rotating the second blocking pieces 45, the first blocking pieces 44 and the second blocking pieces 45 will overlap. Because the exposed portion of the permanent magnet 20 loses the shielding, the generated magnetic field will change the states of the magnetorheological fluid. The drawing shows the four first blocking pieces 44 and second blocking pieces 45, but the present disclosure is not limited by the number of the blocking pieces in this embodiment. The number of the blocking pieces and the methods of rotation can be adjusted in accordance with requirements. The setup of the field blocker 40″ can change the proportion covering the permanent magnet 20. By changing the shielded area, the intensity of the magnetic field can be controlled, and the states of the magnetorheological fluid can further be controlled.

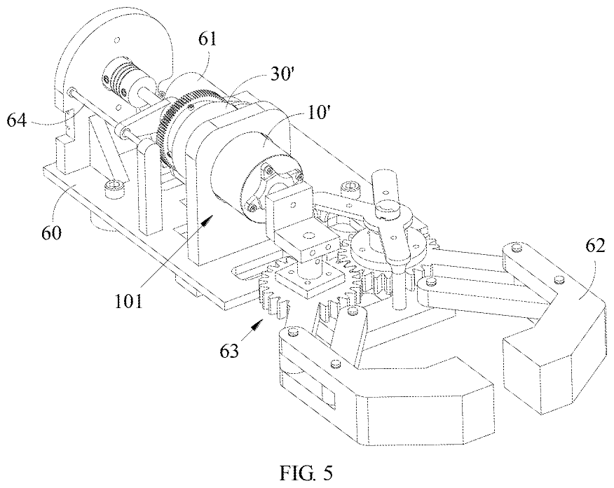

Please refer to FIG. 5, illustrating the diagram of the application of the magnetorheological fluid clutch on a robotic arm of the embodiment of the present disclosure. As indicated in the drawing, the magnetorheological fluid clutch 101 is set up on a platform 60. The magnetorheological fluid clutch 101 includes an output component 10′ and an input component 30′. The output component 10′, the input component 30′, and the disposed magnetorheological fluid are identical to those of embodiments mentioned above. The identical content will not be explained again. In this embodiment, the input component 30′ is connected to the driving motor 61 which propels the input component 30′ with the use of transmission devices, such as a gear box. The output component 10′ can be connected to the robotic arm 62 by a driving device, for instance, the clamping arm shown in the drawing. The driving device includes gear sets 63, containing a vertical gear set and a horizontal gear set. The gear sets 63 are respectively connected to two wrists of the clamping arm, propelling the two wrists to clamp objects.

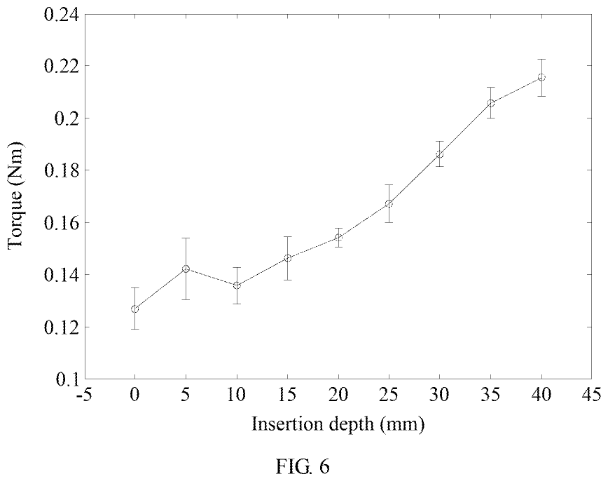

In this embodiment, the guiding device for controlling the field blocker can be connected to a guiding rod 64. By controlling the position of the guiding rod 64, the distance of the field blocker being inserted into the magnetorheological fluid clutch 101 can be driven. By the differences of distances, the intensity of the inner magnetic field can be controlled, thereby affecting the states of the magnetorheological fluid. This further allows the power from the driving motor 61 to propel the robotic arms 62 via the torque outputted by the input component 30′ and the output component 10′. Through an actual test, the relationship between the distance of the field blocker insertion and the output torque can be shown in FIG. 6. Therein, the horizontal axis represents the insertion depth, namely the distance between the tail end of the field blocker and the opening of the clutch. The vertical axis then represents the output value of the detected output torque. As indicated in the drawing, this embodiment can surely achieve the effectiveness of controlling the output torque by insertion depth of field blocker. In addition, in another embodiment, the application device of the magnetorheological fluid clutch 101 combined with the driving motor 61 and the robot arm 62 can also be achieved through the use of different types of field blockers. For instance, the structures of a plurality of cylinders and a plurality of blocking pieces can also control the magnetic field generated by the permanent magnet in the magnetorheological fluid clutch 101 by using the field blocker to achieve the effectiveness of controlling the output torque.

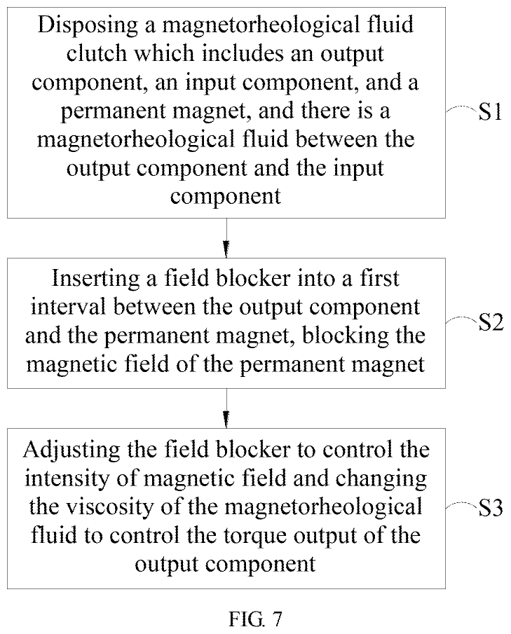

Please refer to FIG. 7, illustrating the flow chart of the magnetorheological fluid clutch operation method of the embodiment of the present disclosure. As indicated in the chart, the magnetorheological fluid clutch operation method includes steps (S1˜S3) as follows:

Step S1: Dispose the magnetorheological fluid clutch, including the output component, input component, and permanent magnet. The magnetorheological fluid is included between the output component and the input component. According to the disposing method in the embodiments regarding the magnetorheological fluid clutch mentioned above, the permanent magnet can be disposed on the output component. The magnetorheological fluid can be disposed on the interval between the output component and the input component. The magnetic field can be generated, which controls the states of the magnetorheological fluid by using the permanent magnet.

Step S2: Insert the field blocker into the first interval between the output component and the permanent magnet to block the magnetic field generated by the permanent magnet. To control the magnetic field generated by the permanent magnet, the field blocker is inserted between the output component and the permanent magnet to shield the effect of the magnetic field. The blocking method mentioned here includes adjusting the insertion depth of the field blocker by using the guiding rod to adjust the intensity of the magnetic field according to the proportion of the shielded area. In another embodiment, the blocking method includes a plurality of cylinders which fold the field blocker. Folding the cylinders with different inner diameters and adjusting the proportion which shields the permanent magnet can further achieve the effectiveness of adjusting the intensity of the magnetic field. In the other embodiment, the blocking method includes a plurality of blocking pieces which rotate the field blocker. Adjusting the proportion covering the area of the permanent magnet can further achieve the effectiveness of adjusting the intensity of the magnetic field.

Step S3: Adjust the field blocker to control the intensity of magnetic field and change the viscosity of the magnetorheological fluid to control the torque output of the output component. After the intensity of the magnetic field applied to the magnetorheological fluid on the permanent magnetic field changes, the states of the magnetorheological fluid will change accordingly. In the meantime, the degree of fixation of the output component and the input component will also change which leads to the need of adjusting the torque output of the output component. Similar to the application of the magnetorheological fluid clutch mentioned above, the input component can receive the power transmitted by the driving motor. By the output component, the torque can be outputted to the driving device to operate the robotic arm. For instance, the clamping force of the clamping arm can be adjusted and controlled in the manner of the method of this embodiment.

The embodiments stated above are only illustrative examples which do not limit the present disclosure. Any spirit and scope without departing from the present disclosure as to equivalent modifications or alterations is intended to be included in the following claims.

What is claimed is:

1. A magnetorheological fluid clutch, comprising:
an output component, forming an accommodating space by an inner sidewall;
a permanent magnet, disposed in the accommodating space, and a first interval being provided between the permanent magnet and the inner sidewall;
an input component, set into the inner sidewall of the output component, and a second interval being provided between the input component and the inner sidewall;
a magnetorheological fluid, disposed in the second interval, and a viscosity of the magnetorheological fluid being controlled by a magnetic field generated by the permanent magnet; and
a field blocker, inserted into the first interval, and controlling the intensity of the magnetic field.

2. The magnetorheological fluid clutch according to claim 1, wherein the field blocker is connected to a guiding rod to adjust an insertion depth of the field blocker and control the intensity of the magnetic field by the guiding rod.

3. The magnetorheological fluid clutch according to claim 1, wherein the field blocker comprises a plurality of cylinders, the plurality of cylinders has different inner diameters, and the intensity of the magnetic field is controlled by folding the plurality of cylinders.

4. The magnetorheological fluid clutch according to claim 1, wherein the field blocker comprises a plurality of blocking pieces, and a proportion covering the permanent magnet is adjusted to control the intensity of the magnetic field by rotating the plurality of blocking pieces.

5. The magnetorheological fluid clutch according to claim 1, wherein the inner sidewall comprises a concave slot, and the input component is inserted into the concave slot to be set into the output component.

6. The magnetorheological fluid clutch according to claim 1, wherein the input component comprises a bearing attaching to the inner sidewall.

7. The magnetorheological fluid clutch according to claim 1, wherein the output component is connected to a driving device of a robotic arm.

8. The magnetorheological fluid clutch according to claim 1, wherein the input component is connected to a driving motor.

9. An operation method of a magnetorheological fluid clutch, comprising:
disposing the magnetorheological fluid clutch comprising an output component, an input component and a permanent magnet, and a magnetorheological fluid being disposed between the output component and the input component;
inserting a field blocker into a first interval between the output component and the permanent magnet, blocking a magnetic field of the permanent magnet.
adjusting the field blocker to control the intensity of magnetic field, and changing the viscosity of the magnetorheological fluid to control a torque output of the output component.

10. The operation method of the magnetorheological fluid clutch according to claim 9, wherein the step of adjusting the field blocker comprises adjusting an insertion depth of the field blocker by using a guiding rod.

11. The operation method of the magnetorheological fluid clutch according to claim 9, wherein the step of adjusting the field blocker comprises folding a plurality of cylinders of the field blocker.

12. The operation method of the magnetorheological fluid clutch according to claim 9, wherein the step of adjusting the field blocker comprises rotating a plurality of blocking pieces of the field blocker to adjust a proportion covering the permanent magnet.

13. The operation method of the magnetorheological fluid clutch according to claim 9, further comprising:
driving the input component through a driving motor; and
receiving the torque output by a driving device to control a robotic arm.
